(19) United States
(12) Patent Application Publication
(10) Pub. No.: US 2016/0052006 A1
(43) Pub. Date: Feb. 25, 2016

(54) Spray Bottle

(71) Applicant: Sheila S. Pirtle, Decatur, AL (US)

(72) Inventor: Sheila S. Pirtle, Decatur, AL (US)

(21) Appl. No.: 14/930,321

(22) Filed: Nov. 2, 2015

Related U.S. Application Data
(63) Continuation-in-part of application No. 14/087,686, filed on Nov. 22, 2013.

(51) Int. Cl. B05B 11/00

(52) U.S. Cl. CPC B05B 11/0037; B05B 11/3045

(57) ABSTRACT

A spray bottle comprises a bottom portion defining a generally cylindrical container having a first diameter and with an opening defined by a threaded lip having a second diameter slightly less than that of the first diameter, and a top portion comprising a neck portion and a generally cylindrical portion with threaded opening dimensioned to threadably engage said threaded lip of the bottom portion, and where the first diameter is at least about 50% greater than the dimension of the neck portion.

### CROSS REFERENCE TO RELATED APPLICATION

This application is a continuation-in-part of and claims priority to U.S. patent application Ser. No. 14/087,686 entitled Spray Bottle filed on Nov. 22, 2013, which is incorporated by reference in its entirety.

### BACKGROUND

Spray bottles are oftentimes used in cleaning. A liquid cleaner is poured into the spray bottle. The cleaner is then sprayed on an article in need of cleaning. The user then wipes the cleaner on the article, thereby cleaning it.

Most spray bottles have a thin threaded neck that attach to a spray mechanism. In use, the spray mechanism is removed from the thin threaded neck, and the liquid cleaner is poured into the thin threaded neck to fill the spray bottle with the cleaner. It is often difficult to pour the cleaner into the spray bottle, because the neck is so thin

### BRIEF DESCRIPTION OF THE DRAWINGS

The apparatus is described with reference to the accompanying drawings. In the drawings, like reference numbers indicate identical or functionally similar elements.

FIG. 1A illustrates a spray bottle according to one embodiment.

FIG. 1B is a cross-sectional view taken along line A-A in FIG. 1A.

FIG. 1C is a cross-sectional view taken along line B-B in FIG. 1A.

FIG. 1D is a cross-sectional view taken along line C-C in FIG. 1A.

FIG. 2 illustrates a spray bottle according to another embodiment.

### DETAILED DESCRIPTION

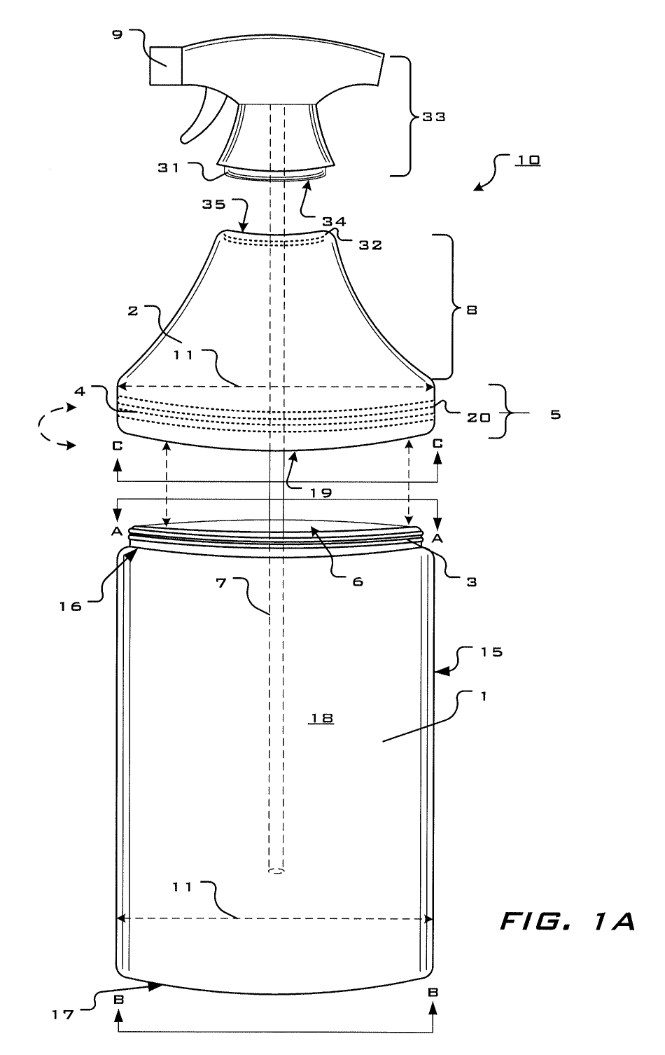

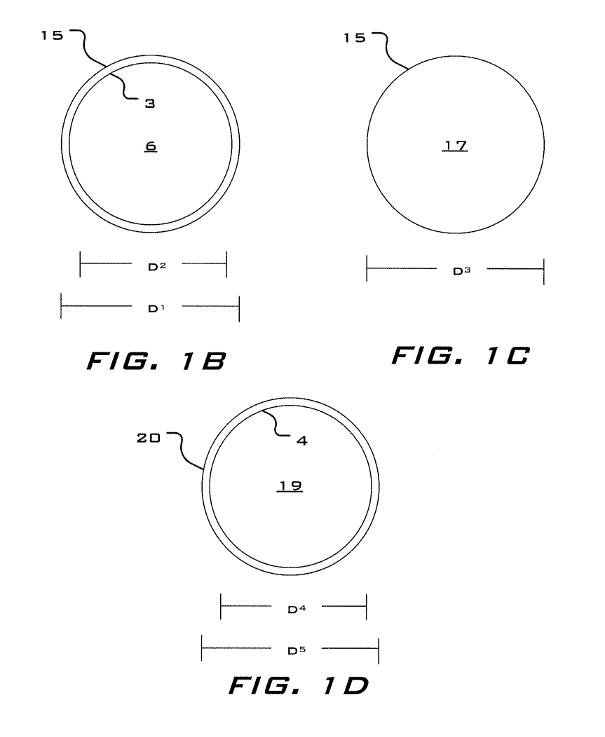

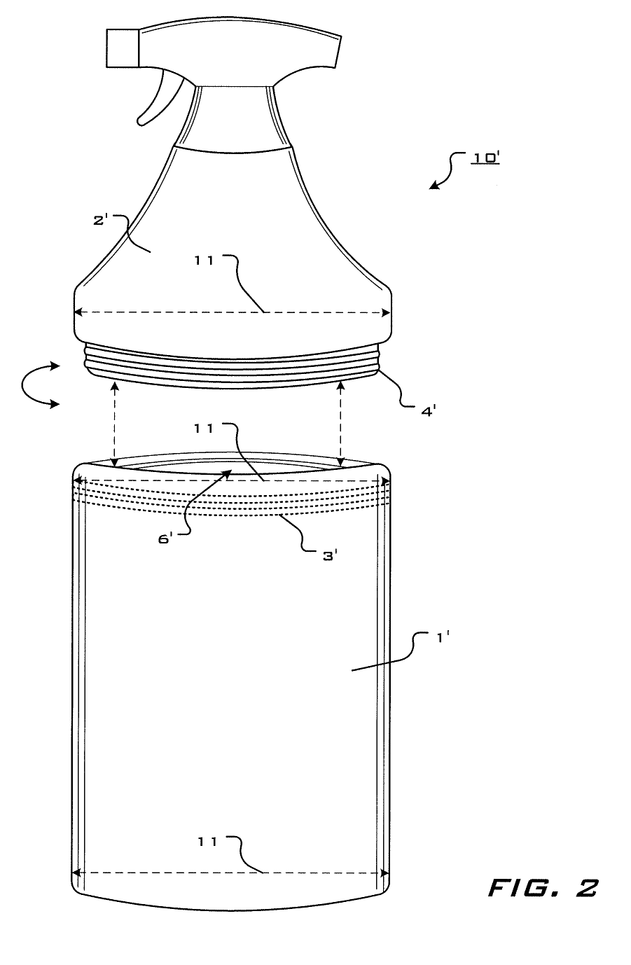

The various embodiments and their advantages are best understood by referring to FIGS. 1 and 2 of the drawings. The elements of the drawings are not necessarily to scale. Throughout the drawings, like numerals are used for like and corresponding parts of the various drawings.

FIG. 1A depicts a spray bottle 10 having a bottom container portion 1, a middle portion 2, and a cap portion 33. The bottom container portion 1 is adapted to contain a fluid to be sprayed. The cap portion 33 comprises a spray mechanism 9 with a trigger for drawing the fluid from the bottom container portion 1 through tube 7 in the conventional manner. The middle portion 2 comprises a neck portion 8 which is sufficiently narrow to be comfortably held in an adult hand such that the index finger of which may operate the trigger of the spray mechanism 9.

The bottom container portion 1 is generally cylindrical having a first diameter 11 that is at least 50% greater than the dimensions of the neck portion 8 with an opening 6 defined by a male threaded lip 3. The opening 6 defines a wide mouth having a diameter slightly less than that of the diameter of the remainder of the bottom container portion 1.

The cap portion 33 comprises a male threaded opening 34 having a threaded lip 31. Further, the middle portion 2 comprises an upper opening 35 having female threads 32. Notably, upper opening 35 receives the male threaded opening 35, and the threaded lip 31 rotatably couple to the threads 32. Additionally, the middle portion 2 comprises a lower opening 19 having female threads 4. The lower opening 19 receives the male threaded opening 6, and the threads 4 couple to the threaded lip 3 of the bottom container portion 1.

A cavity 18 is formed by a cylindrical wall 15. The cylindrical wall 15 extends from a top edge 16 from which the threaded lip 3 of the container portion 1 extends and exhibits a constant diameter 11 to the bottom edge 17 of the bottom container portion 1.

The middle portion 2 includes a cylindrical portion 5 that includes the opening 19 defined by the female threaded portion 4. The cylindrical portion 5 is defined by a cylindrical wall 20. The female threaded portion 4 is dimensioned to threadably engage the male threaded lip 3 in the usual manner and snugly mate the bottom container portion 1 to the top portion 2. Note that the cylindrical portion 5 has the same diameter 11 as the cylindrical portion.

FIG. 1B is a cross-sectional view taken along line A-A in FIG. 1A. Notably, the threaded lip 3 has a diameter D₂, and the cylindrical wall 15 of the container portion 1 (FIG. 1A) has a diameter D₁. Diameter D₂ is less than diameter D1.

FIG. 1C is a cross-sectional view taken along line B-B in FIG. 1A. The bottom surface 17 has a diameter D₃, which is defined by the cylindrical wall 15. Note that D₃, the diameter at the bottom surface 17, is equal to D₁, the diameter of the cylindrical wall 15 that is contiguous with the threaded portion 3.

FIG. 1D is a cross-sectional view taken along line C-C in FIG. 1A. The opening 19 is defined by a threaded portion 4 having a diameter D₅. Further, the cylindrical portion 5 (FIG. 1A) of the top portion 2 has a diameter D₄. Note that in the embodiment depicted, D₁ is equal to D₃, which is equal to D₅.

FIG. 2 depicts an embodiment nearly identical to the first, but which the bottom portion 1′ comprises a female threaded portion 3′ and the top portion 2′ comprises a male threaded portion 4′.

As described above and shown in the associated drawings, the present invention comprises a spray bottle. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A spray bottle comprising:
a bottom portion defining a generally cylindrical container having a first diameter and with a first opening defined by a first threaded lip having a second diameter slightly less than that of the first diameter, the bottom portion further comprising a cylindrical wall defining a cavity therein, wherein the cylindrical wall has a constant diameter from a top edge of the bottom portion to a bottom edge of the bottom portion;
a middle portion having a first threaded opening dimensioned to threadably engage said threaded lip of said bottom portion and a second threaded opening; and
a cap portion comprising a spray mechanism extending from a neck portion, the neck portion having a adapted to be held by hand and to allow operation of the spray mechanism, said top portion further comprising a generally cylindrical portion with a second opening defined by a second threaded lip and dimensioned to threadably engage said second opening of said middle portion.
